(19) United States
(12) Patent Application Publication
(10) Pub. No.: US 2025/0286967 A1
(43) Pub. Date: Sep. 11, 2025

(54) NON-TRANSITORY COMPUTER READABLE STORAGE MEDIUM AND INFORMATION PROCESSING APPARATUS

(71) Applicant: BROTHER KOGYO KABUSHIKI KAISHA, Nagoya (JP)

(72) Inventor: Satoshi MATSUSHITA, Nagoya (JP)

(21) Appl. No.: 19/069,734

(22) Filed: Mar. 4, 2025

(30) Foreign Application Priority Data
Mar. 6, 2024 (JP) 2024-034174

(51) Int. Cl. H04N 1/00

(52) U.S. Cl. CPC H04N 1/0048; H04N 1/00424; H04N 1/00472; H04N 1/00477

(57) ABSTRACT

A non-transitory computer readable storage medium stores a program that is a resident program. The program, when executed by a processor of an information processing apparatus, causes the information processing apparatus to perform operations including: acquiring a status of the image processing device through a communication with an image processing device to be monitored; displaying a first notification image based on the status acquired in the acquiring the status of the image processing device; acquiring service-related information related to a service available to the image processing device to be monitored; and displaying a second notification image related to the service-related information acquired in the acquiring the service-related information. A display format of the second notification image is the same as a display format of the first notification image.

### REFERENCE TO RELATED APPLICATIONS

This application claims priority from Japanese Patent Application No. 2024-034174 filed on Mar. 6, 2024. The entire content of the priority application is incorporated herein by reference.

### BACKGROUND ART

The technical field disclosed in the present specification relates to a non-transitory computer readable storage medium storing a resident program, and an information processing apparatus, particularly, the resident program is configured to communicate with an image processing device.

As an example of a resident program that functions as a resident process, which is resident after an information processing apparatus is activated and continues processing, there is a program for communicating with an image processing device to be monitored. For example, a status monitor caused to function by a resident program periodically communicates with a printer, acquires a status of the printer, and generates a notification of information indicating the status as necessary.

### DESCRIPTION

The above-described resident program causes the information processing apparatus to communicate with the image processing device to be monitored and notify a user of information based on a status of the image processing device to be monitored. However, there is various information related to the image processing device in addition to the information based on the status, and there may be a need to effectively generate notifications of various information.

In an aspect of the present disclosure, there is provided a non-transitory computer readable storage medium storing a program that is a resident program, the program, when executed by a processor of an information processing apparatus, causing the information processing apparatus to perform operations, the operations including: communicating, via a communication device of the image processing apparatus, with an image processing device to be monitored; acquiring a status of the image processing device through a communication with the image processing device; displaying a first notification image based on the status acquired in the acquiring the status of the image processing device; acquiring service-related information related to a service available to the image processing device to be monitored; and displaying a second notification image related to the service-related information acquired in the acquiring the service-related information, a display format of the second notification image being the same as a display format of the first notification image.

According to the technique disclosed in the present specification, the program allows the information processing apparatus to communicate with the image processing device to be monitored and notify the user of the information based on the status, and furthermore, to notify the user of service-related information related to the image processing device to be monitored in the same display format as that of the information based on the status. Consequently, various information related to the image processing device to be monitored can be effectively provided to the user.

An information processing apparatus configured to achieve the operations by the above program is also novel and useful.

According to the technique disclosed in the present specification, a technique of effectively generating notifications of various information is achieved in a resident program for communicating with an image processing device.

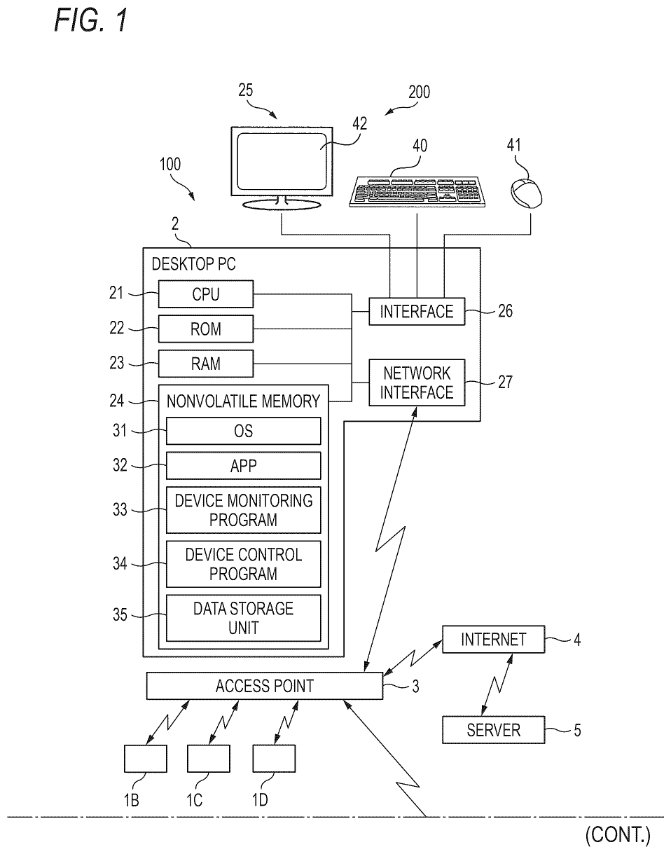

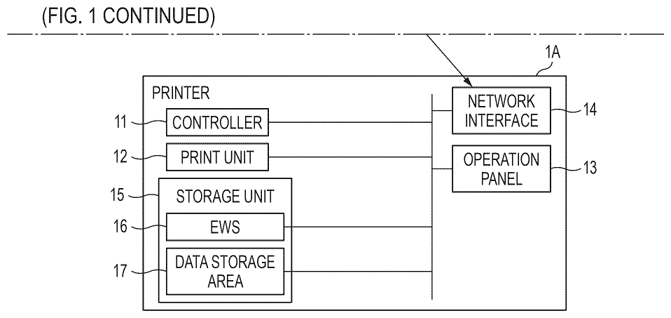

FIG. 1 is a schematic diagram of an information processing system according to a first embodiment.

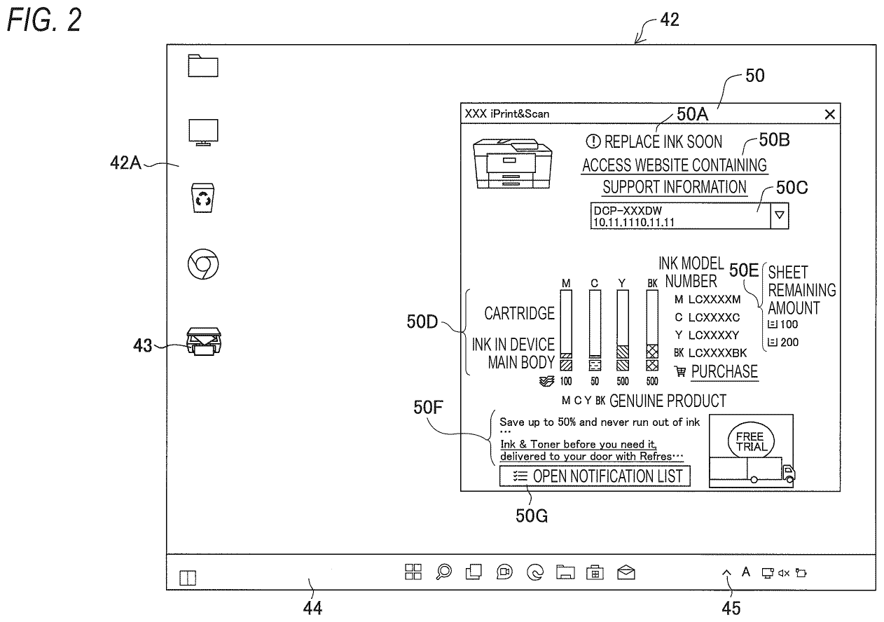

FIG. 2 is a diagram illustrating a display of an operation display unit in a state in which a first status information screen is displayed as a pop-up.

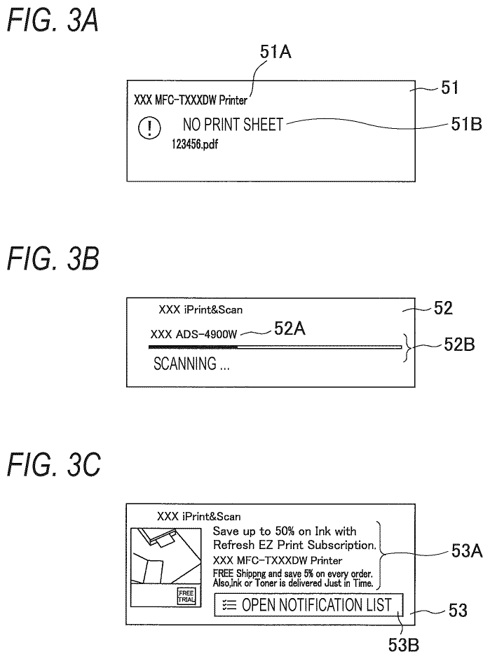

FIG. 3A is a diagram illustrating a second status information screen displayed as a pop-up on the display of the operation display unit; FIG. 3B is a diagram illustrating a third status information screen displayed as a pop-up on the display of the operation display unit; and FIG. 3C is a diagram illustrating an offering information screen displayed as a pop-up on the display of the operation display unit.

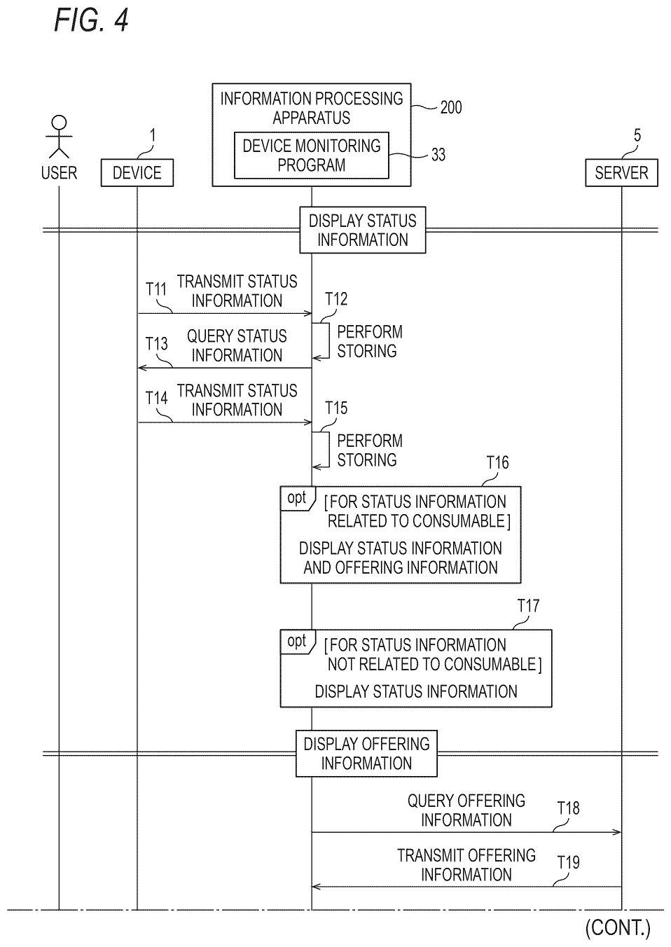

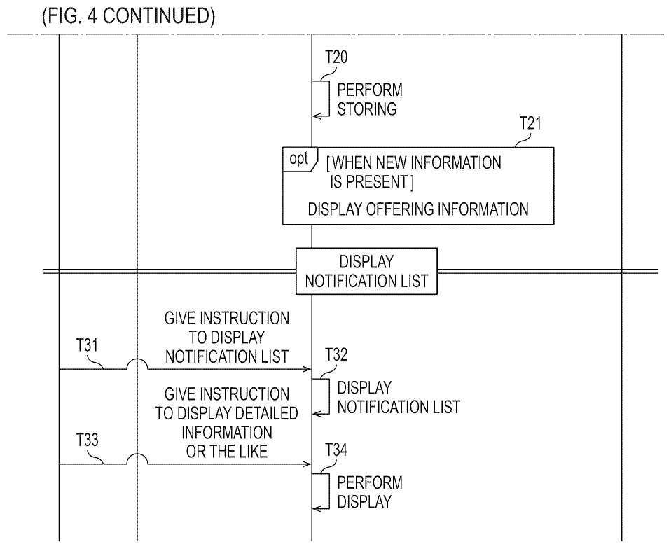

FIG. 4 is a sequence diagram illustrating an example of a procedure for display processing of status information, offering information, and a notification list, which is implemented by a device monitoring program of an information processing apparatus, including operations of a device and a server.

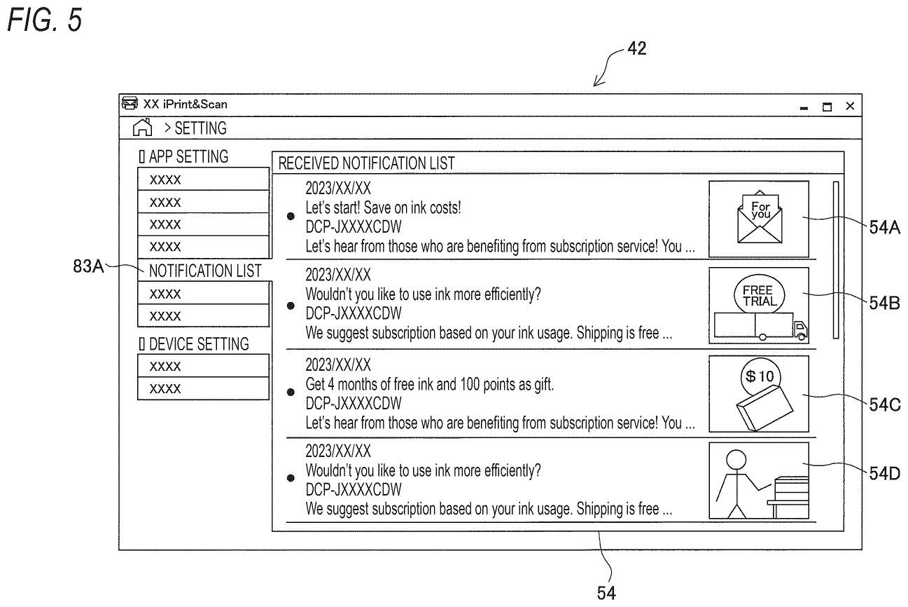

FIG. 5 is a diagram illustrating an example of a notification list screen.

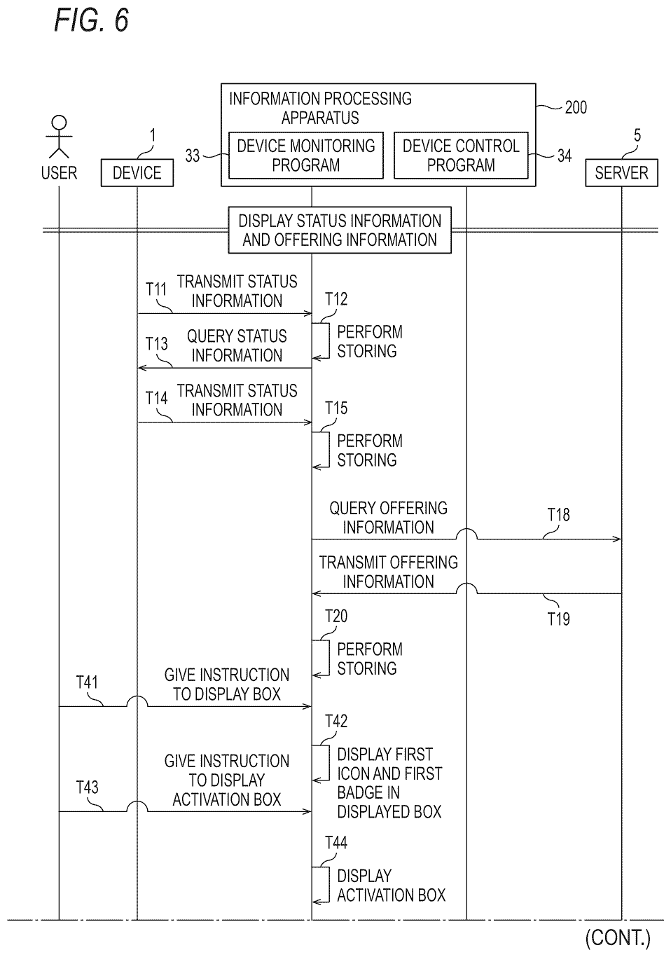

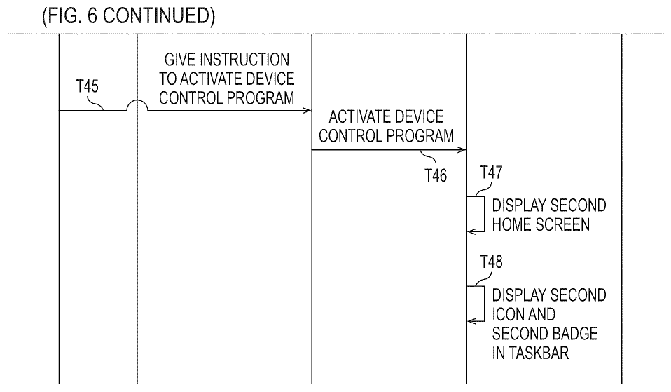

FIG. 6 is a sequence diagram illustrating an example of a procedure for display processing of status information and offering information, which is implemented by a device monitoring program and a device control program of an information processing apparatus, including operations of a device and a server, according to a second embodiment.

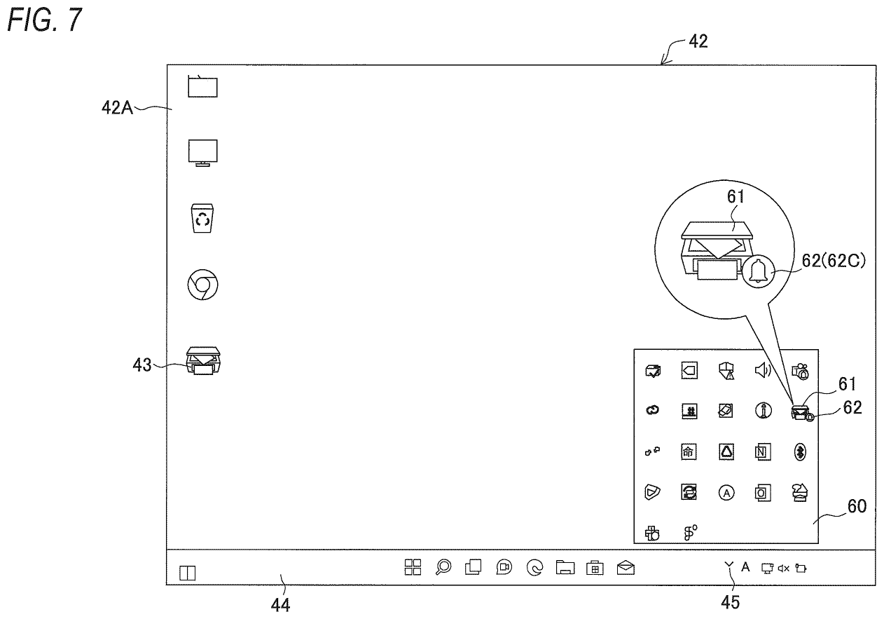

FIG. 7 is a diagram illustrating an example of a display in a state in which a task box is displayed as a pop-up.

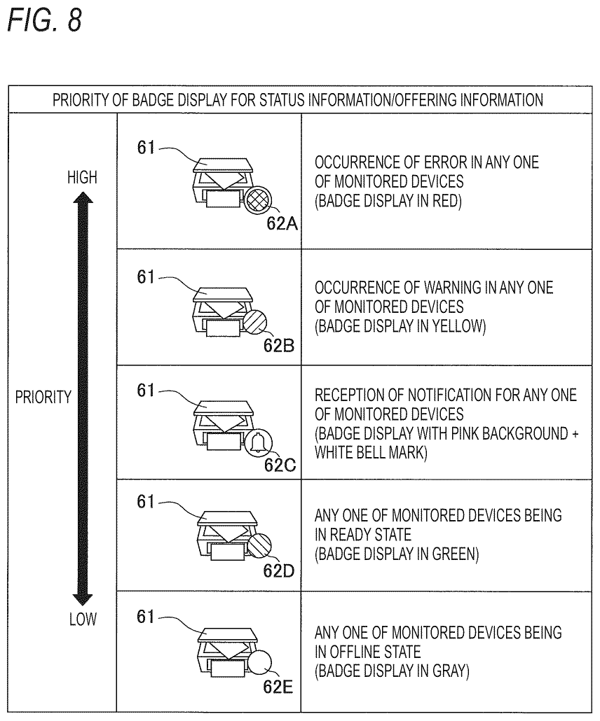

FIG. 8 is a diagram illustrating a display method and a priority of a first badge.

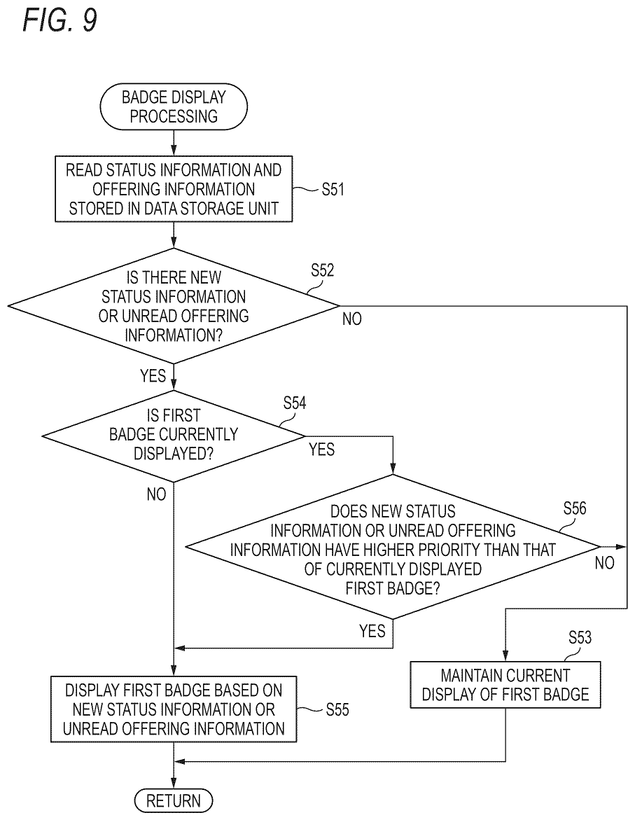

FIG. 9 is a flowchart illustrating an example of a procedure for badge display processing, which is implemented by a CPU of the information processing apparatus sequentially processing according to commands described in the device monitoring program.

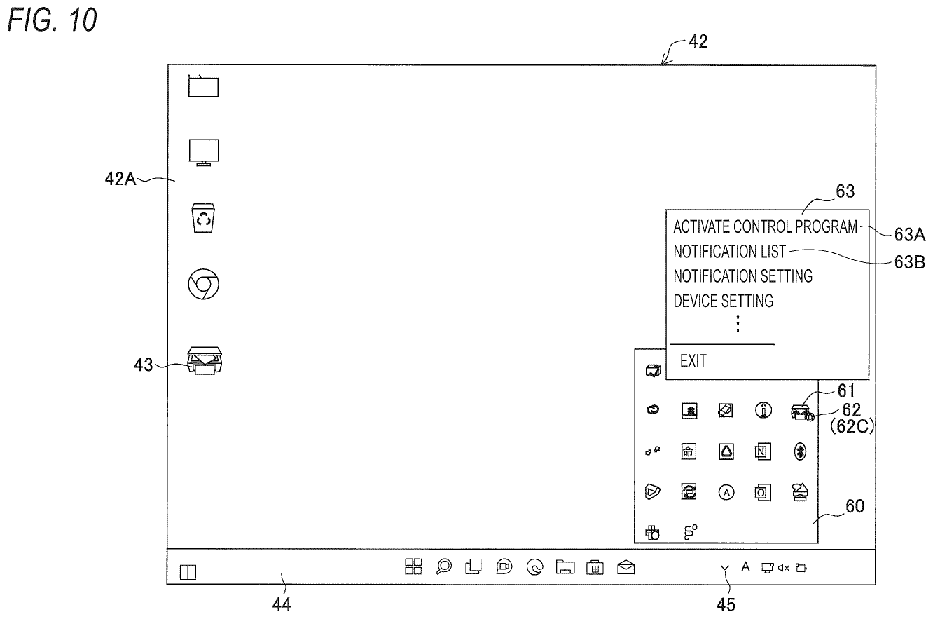

FIG. 10 is a diagram illustrating an example of the display in a state in which an activation box is displayed as a pop-up.

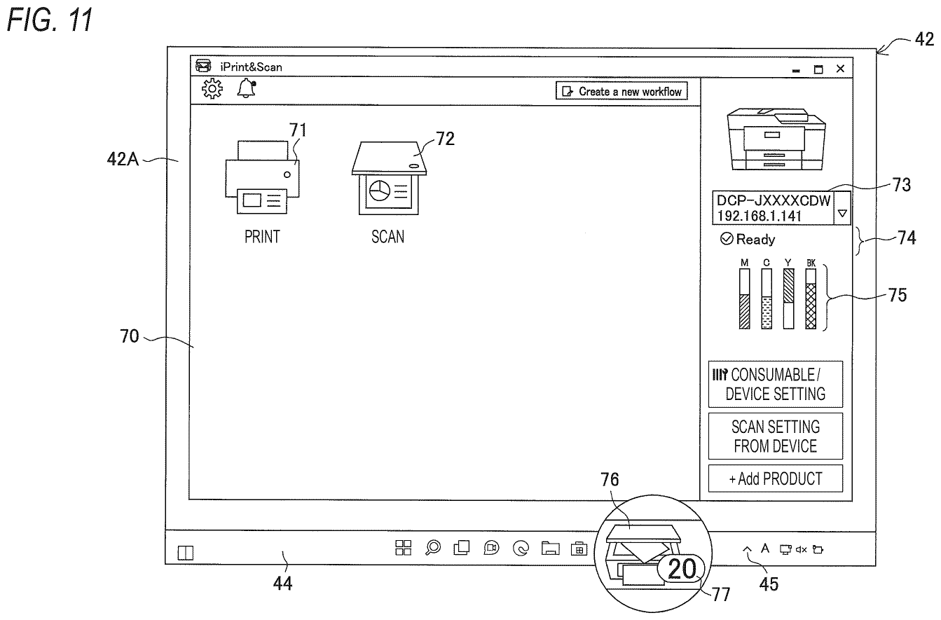

FIG. 11 is a diagram illustrating an example of the display in a state in which a second home screen is displayed.

### FIRST EMBODIMENT

Hereinafter, a specific embodiment of an information processing system according to the present embodiment will be described in detail with reference to the accompanying drawings. In the present embodiment, the present disclosure is applied to the information processing system including a printer and an information processing apparatus that can communicate with each other.

That is, as illustrated in FIG. 1, an information processing system 100 according to the present embodiment includes four devices 1A, 1B, 1C, and 1D and an information processing apparatus 200, which are communicatively connected to each other. In the following description, when there is no need to distinguish between the devices 1A, 1B, 1C, and 1D, the subscripts for distinguishing A to D will be omitted and the devices will be described as a device 1. The device is an example of an image processing device.

The device 1 includes a printer 1A capable of printing on a medium to be printed, and an image reading device 1B capable of reading an image recorded on a medium to be read. In the present embodiment, the printer 1A is exemplified as an inkjet printer. As a modification, the printer 1A may be a laser printer, a label printer, a copier, or a multi function device. The information processing apparatus 200 generates and edits image data to be printed by the printer 1A, transmits a print execution instruction and the image data to the printer 1A, and receives status information from the printer 1A.

The information processing apparatus 200 transmits a reading execution instruction to the image reading device 1B, receives read data from the image reading device 1B, and receives status information from the image reading device 1B. The image reading device 1B may be a copier, a multi function device, or the like.

The information processing apparatus 200 is, for example, a smartphone, a personal computer, or a tablet computer. The number of information processing apparatus 200 constituting the information processing system 100 is not limited to one. A plurality of information processing apparatus may be provided.

As illustrated in FIG. 1, in the present embodiment, the printer 1A includes a controller 11, a print unit 12, an operation panel 13, a network interface 14, and a storage unit 15. The controller 11 includes a CPU and memories such as a flash ROM and a RAM, and controls each component of the printer 1A.

The controller 11 is a general term for hardware used to control the printer 1A, such as the CPU. Specifically, the controller 11 may also include an application specific integrated circuit (ASIC) and the like.

The print unit 12 is configured to print an image on a medium to be printed based on the image data transmitted from the information processing apparatus 200. In the present embodiment, an inkjet printing method is adopted as an image forming method of the print unit 12. The print unit 12 includes a print head that prints an image on a medium. Further, the print unit 12 may also be referred to as a print engine. The image forming method of the print unit 12 may be a thermal printing method or an electrophotographic method.

The operation panel 13 is, for example, a touch panel, receives an input from a user, and displays information. The operation panel 13 may include various display lamps, buttons, and the like.

The network interface 14 is hardware for communicating with the information processing apparatus 200.

The storage unit 15 of the printer 1A stores a program for an embedded web server (hereinafter, referred to as “EWS” (abbreviation of embedded web server)) 16. Further, the storage unit 15 has a data storage area 17, and the data storage area 17 stores, for example, capability information on the printer 1A, connection information for connecting to the printer 1A, status information on the printer 1A, various setting information set in the printer 1A, consumable remaining amount information on the printer 1A, printed sheet number information on the printer 1A, and consumable support-related information.

For example, the information processing apparatus 200 can access various information stored in the data storage area 17 via the EWS 16. The printer 1A manages a print progress status for each transmission source of a job. In the present embodiment, the consumable is an ink cartridge that contains ink consumed in print processing of a printer, and the remaining amount information is information related to a remaining amount of ink contained in the ink cartridge.

The devices 1B to 1D also include an EWS similar to the EWS 16 of the printer 1A, and a storage unit (both not illustrated).

In the present embodiment, as illustrated in FIG. 1, the information processing apparatus 200 includes a desktop personal computer (PC) 2 and an input and output device 25. The desktop personal computer (PC) 2 includes a CPU 21, a ROM 22, a RAM 23, a non-volatile memory 24, an interface 26, and a network interface 27. The ROM 22 stores various programs and the like for the information processing apparatus 200. The RAM 23 is used as a work area when various processing is executed, or as a storage area for temporarily storing data. The non-volatile memory 24 is, for example, a hard disk drive (HDD), a solid state drive (SSD), a flash memory, or the like, and stores various programs and data.

The CPU 21 executes various processing according to programs loaded from the ROM 22 to the non-volatile memory 24.

The input and output device 25 is connected to the interface 26, and includes an input device and an output device. The input device includes a keyboard 40, a mouse 41, and the like. The output device includes a display 42. The display 42 is, for example, a liquid crystal display or an organic EL display. The input and output device 25 may be a touch panel that can be operated by touch. The information processing apparatus 200 may be a notebook PC or a tablet PC.

The network interface 27 is hardware for communicating with each device 1. The network interface 27 is an example of a communication unit.

In the information processing system 100 according to the present embodiment, the information processing apparatus 200 and each device 1 perform wireless communication conforming to a Wi-Fi (registered trademark) standard via a common access point 3. That is, the network interfaces 14 and 27 are both wireless interfaces that enable wireless communication based on the Wi-Fi (registered trademark) standard. The network interfaces 14 and 27 may be wired interfaces such as wired local area network (LAN) interfaces.

The communication mode according to the present embodiment is an example, and is not limited to the above mode. For example, the information processing apparatus 200 and each device 1 may communicate with each other by wireless communication through a direct connection without going through the access point 3, or by wired communication using an interface such as USB.

The access point 3 is connected to a server 5 provided by a manufacturer, a sales company, or the like of the device 1 via an Internet 4. Therefore, the information processing apparatus 200 can download a manual or the like of the device 1 from the server 5 via the Internet 4. In addition to the manual, offering information such as service information and bargain information related to a consumable of the device I can be downloaded from the server 5.

Examples of a service related to a consumable include an automatic consumable delivery service and a subscription service. The automatic consumable delivery service is a service that automatically delivers a consumable to a user of the printer based on consumable remaining amount information. The subscription service is a service that charges a fixed amount for up to a predetermined number of printed sheets of the printer, and automatically delivers the consumable to the user of the printer based on the consumable remaining amount information.

As illustrated in FIG. 1, the non-volatile memory 24 of the information processing apparatus 200 stores an operating system (OS) 31, an application program (app) 32, a device monitoring program 33, and a device control program 34. Further, the nonvolatile memory 24 includes a data storage unit 35.

The OS 31 is, for example, Windows (registered trademark), macOS (registered trademark), Linux (registered trademark), iOS (registered trademark), or Android (registered trademark). In the present embodiment, the OS 31 is Windows.

The app 32 is, for example, an image editing program having a function of receiving a user instruction via the interface 26, a function of displaying an image on the display 42, and a function of editing and saving the image. The app 32 may be a document editing program, a spreadsheet program, or the like.

The device monitoring program 33 is a resident program, and is a program for implementing a function of periodically communicating with each device 1 via the network interface 27 and acquiring various status information and the like from each device 1. Further, the device monitoring program 33 is a program for implementing a function of periodically communicating with the server 5 via the network interface 27 and acquiring various information from the server 5.

The resident program is, for example, a program that is automatically activated when the OS is activated and performs predetermined processing in a background during activation of the OS. The device monitoring program 33 is an example of a first program.

Specifically, the device monitoring program 33 acquires, from the printer 1A via the network interface 27, the capability information on the printer 1A, the connection information for connecting to the printer 1A, the status information on the printer 1A, the various setting information set in the printer 1A, the consumable remaining amount information on the printer 1A, the printed sheet number information on the printer 1A, the consumable support-related information, information on the print progress status, and the like, and stores the acquired information in the data storage unit 35.

Further, the device monitoring program 33 acquires, from the image reading device 1B via the network interface 27, capability information on the image reading device 1B, connection information for connecting to the image reading device 1B, status information on the image reading device 1B, various setting information set in the image reading device 1B, information related to a read progress status, and the like, and stores the acquired information in the data storage unit 35.

Further, the device monitoring program 33 acquires, via the network interface 27, the offering information related to the device 1 provided by the manufacturer or the sales company of the device 1, and stores the acquired offering information in the data storage unit 35. The offering information includes consumable-related service information and bargain information, maintenance information, notification of a campaign, a latest model, and introductions of convenient functions. Further, the offering information may include link information to the server 5. The offering information is an example of service-related information.

Then, the device monitoring program 33 can read the status information, the offering information, and the like of the device 1 stored in the data storage unit 35, and display the read information as a pop-up on the display 42.

The device control program 34 has a function of causing the printer 1A, which is set in a model name display field 73 described later, to print an image edited or stored by the app 32. That is, the device control program 34 receives a selection of an image to be printed, and transmits print data based on the selected image to the printer 1A, thereby causing the printer 1A to perform printing based on the print data. This function is an example of transmission processing. The status information, the consumable remaining amount information, and the like on the selected printer 1A can be read from the data storage unit 35 and displayed on the display 42. The device control program 34 is, for example, a non-resident program that is activated when activated and operated by the user. The device control program 34 is an example of a display program.

The device control program 34 instructs the selected image reading device 1B to read, receives image information read by the selected image reading device 1B, and stores the image information in the data storage unit 35. This function is an example of transmission processing. Further, information related to a read progress status of the selected image reading device 1B can be read from the data storage unit 35 and then displayed on the display 42.

The data storage unit 35 stores model names, model numbers, and the like of all the devices 1 to be monitored by the device monitoring program 33.

FIG. 2 is a diagram illustrating an example of a display state of the display 42 in a state in which a first status information screen 50 by the device monitoring program 33 is displayed as a pop-up. That is, on a first home screen 42A of the information processing apparatus 200, an icon 43 for the user to activate the device control program 34 is displayed on a left side of the display 42, and a taskbar 44 is displayed on a lower side of the display 42. A box display button 45 is displayed on a right side of the taskbar 44. The icon 43 for the device control program 34 is not required to be displayed on the first home screen 42A, and the device control program 34 may be activated by an operation on a menu screen of the information processing apparatus 200 (not illustrated).

The first home screen 42A is displayed on the display 42 by the OS, and on the first home screen 42A, the icon 43, the taskbar 44, the box display button 45, and the like are displayed by the OS.

On the first home screen 42A displayed on the display 42, a first status information screen 50 related to a consumable, for example, an ink remaining amount, is displayed as a pop-up. The first status information screen 50 includes a first character string display field 50A in which a character string such as “replace ink soon” is displayed as status information, a second character string display field 50B in which a character string such as “access website containing support information” is displayed and which is linked to an access destination of the server 5, a model name display field 50C in which a model name of the device 1 is displayed, an ink remaining amount display field 50D in which an ink remaining amount is displayed, a sheet remaining amount display field 50E in which a sheet remaining amount is displayed, an offering information display field 50F in which offering information or the like related to the status information displayed in the first character string display field 50A is displayed, a notification list button display field 50G in which a notification list button for displaying a notification list screen is displayed, and the like.

The model name display field 50C displays a model name and an IP address of a corresponding device. Instead of the IP address, other identification information that can uniquely identify the device may be used. As other identification information, for example, a MAC address, a serial number, or the like can be used.

Further, on the first home screen 42A, a second status information screen 51 not related to a consumable, for example, ink, as illustrated in FIG. 3A is displayed as a pop-up by the device monitoring program 33. The second status information screen 51 includes a model name display field 51A in which the model name of the device 1 is displayed, and a second character string display field 51B in which a character string such as “no sheet” is displayed as status information. When the character string “no sheet” is displayed in the second character string display field 51B, the information processing apparatus 200 acquires status information indicating that there is no sheet from the printer 1. This processing is an example of third display processing.

Further, on the first home screen 42A, a third status information screen 52 not related to a consumable, for example, ink, as illustrated in FIG. 3B is displayed as a pop-up by the device monitoring program 33. The third status information screen 52 includes a model name display field 52A in which the model name of the device 1 is displayed, and a progress status display field 52B in which, for example, a scan progress status of the image reading device 1B is displayed as status information.

Further, on the first home screen 42A, an offering information screen 53 that displays offering information or the like as illustrated in FIG. 3C, is displayed as a pop-up by the device monitoring program 33. The offering information screen 53 includes an offering information display field 53A in which offering information is displayed, a notification list button display field 53B in which a notification list button for displaying a notification list screen is displayed, and the like.

The information processing apparatus 200 may be configured such that on the first home screen 42A, the first status information screen 50 that displays the status information related to the consumable, the second status information screen 51 and the third status information screen 52 that display the status information not related to the consumable, and the offering information screen 53 that displays the offering information are displayed as pop-ups not to overlap each other, or these information screens 50 to 52 are overlapped and displayed as pop-ups.

Further, when the information processing apparatus 200 is configured such that a plurality of screens are overlapped and displayed as pop-ups, the information processing apparatus 200 may be configured such that a screen that displays new information is displayed as a pop-up in a foreground. In this case, since the screen that displays the new information is displayed as a pop-up in the foreground, the user can always keep an eye on a latest status of the device and latest information on the device, and acquire the status and the information, enabling a quick response.

### Display of Status Information and Offering Information

FIG. 4 is a sequence diagram illustrating an example of a procedure for displaying the status information, the offering information, and the notification list, which is implemented by the device monitoring program 33 of the information processing apparatus 200, including operations of the device 1 and the server 5.

Each processing step in the present embodiment represents processing of the CPU 21 according to an instruction described in a program such as the device monitoring program 33 of the information processing apparatus 200. The processing by the CPU 21 also includes a hardware control using an API of the OS. In the present specification, a detail description of the OS is omitted, and an operation of each program is described. In addition, in the present specification, for convenience, processing primarily performed by the CPU 21 may be described as being primarily performed by a program or a device.

### Display of Status Information and Offering Information

In FIG. 4, first, in a case in which an error occurs during operation, for example, in a case in which the device 1 is the printer 1A, when a consumable such as ink runs out or an error such as a sheet jam occurs during printing, the device 1 transmits status information indicating error content to the information processing apparatus 200 (procedure 11 (hereinafter, referred to as T11)). Therefore, the device monitoring program 33 that receives the status information stores the received status information in the data storage unit 35 (T12). This procedure is an example of first acquisition processing and fourth acquisition processing.

The device monitoring program 33 queries each device 1 connected to the information processing apparatus 200, that is, each device 1 to be monitored by the device monitoring program 33 for the status information. In other words, the information processing apparatus 200 queries each device 1 at regular intervals, performing a so-called polling (T13). A polling interval for each device 1 may be constant, or may be varied based on, for example, a frequency of use of the device 1.

Each device 1 that receives the query from the information processing apparatus 200 transmits the status information to the information processing apparatus 200 (T14). Therefore, the device monitoring program 33 that receives the status information stores the received status information in the data storage unit 35 (T15). This procedure is an example of the first acquisition processing, third acquisition processing, and the fourth acquisition processing.

When the status information is stored in the data storage unit 35 in T12 or T15, the device monitoring program 33 determines whether the stored status information is status information related to a consumable such as ink provided by the manufacturer or the sales company of the device 1. When the information processing apparatus 200 determines that the status information is status information related to the consumable, as illustrated in FIG. 2, the device monitoring program 33 displays the first status information screen 50 as a pop-up on the first home screen 42A based on content of the status information (T16). This processing is an example of first display processing.

Further, the device monitoring program 33 searches for offering information stored in the data storage unit 35 based on the content of the status information and the model name of the device 1, specifically, for example, warning information “replace ink soon” displayed in the first character string display field 50A and a model name “DCP-XXXDW” displayed in the model name display field 50C, and extracts the offering information stored in association with the warning information and the model name. Then, the information processing apparatus 200 displays the extracted offering information in the offering information display field 50F on the first status information screen 50. This processing is an example of second display processing.

As described above, in the present embodiment, on the first status information screen 50 based on the status information related to the consumable among the status information transmitted from all the devices 1 connected to the information processing apparatus 200, that is, the respective devices 1 to be monitored by the device monitoring program 33, the offering information related to the warning information and the model name is also displayed in the offering information display field 50F, and therefore, by viewing the content displayed as a pop-up, the user can recognize that there is a device 1 having a predetermined status, or that there is offering information related to the status, thereby improving user convenience. Further, an improvement in user ability to cope with the status information can also be expected.

At this time, as the offering information displayed in the offering information display field 50F, only the offering information unread by the user may be displayed, or all the offering information related to the warning information and the model name may be displayed regardless of whether the offering information is read or unread by the user. The offering information is stored in the data storage unit 35 in association with information indicating whether the offering information is unread or read. Information indicating the offering information is unread is associated immediately after being received from the server 5, and when the offering information is displayed on the first status information screen 50 or the like, information indicating the offering information is read is associated instead of the information indicating the offering information is unread.

In the present embodiment, the device monitoring program 33 is configured to display the offering information stored in the data storage unit 35 in the offering information display field 50F on the first status information screen 50. However, the device monitoring program 33 may be configured to download the offering information from the server 5 by querying the server 5 for offering information based on the content of the status information, the model name of the device 1, and the like, and display the offering information in the offering information display field 50F on the first status information screen 50 based on the offering information downloaded from the server 5.

Next, the device monitoring program 33 determines whether the status information stored in the data storage unit 35 is status information related to a consumable such as ink provided by the manufacturer or the sales company of the device 1. When the device monitoring program 33 determines that the status information is not status information related to the consumable provided by the manufacturer or the sales company of the device 1, such as running out of print sheet, the device monitoring program 33 displays the second status information screen 51 as illustrated in FIG. 3A or the third status information screen 52 as illustrated in FIG. 3B as pop-ups on the first home screen 42A based on the content of the status information (T17). The second status information screen 51 is a screen indicating that there is no sheet in the device, and the third status information screen 52 is a screen indicating that scan processing is being executed in the device. This processing is an example of the first display processing and the third display processing, and the second status information screen 51 is an example of a third notification screen.

As described above, in the present embodiment, in a case in which the status information is not status information related to a consumable such as ink provided by the manufacturer or the sales company of the device 1, that is, for example, no offering information is displayed on the second status information screen 51 that notifies the user of out-of-sheet or the third status information screen 52 that displays the scan progress status of the image reading device 1B, and therefore, no unnecessary information is provided to the user, improving visibility of the user.

When the device monitoring program 33 receives the same status information from the device 1 while displaying a screen based on certain status information from the device 1 as a pop-up, the device monitoring program 33 may omit further displaying a screen based on the received status information as a pop-up.

Further, the device monitoring program 33 queries the server 5 connected to the information processing apparatus 200 for offering information, that is, the information processing apparatus 200 performs a so-called polling on the server 5 (T18). The query is accompanied by information indicating a time of a previous query. When offering information not transmitted to the information processing apparatus 200 is present, that is, new offering information registered after a time indicated by the accompanied information is present, the server 5 that receives the query transmits the new offering information to the information processing apparatus 200 (T19). Therefore, the device monitoring program 33 that receives the offering information stores the received offering information in the data storage unit 35 that is accessible by the device control program 34 (T20). This procedure is an example of second acquisition processing.

A polling interval for the server 5 may be the same as the polling interval for each device 1 performed by the information processing apparatus 200, or the polling intervals for the device 1 and the server 5 may be different. For example, the polling interval for the server 5 may be set longer than the polling interval for the device 1. Further, the polling interval for the server 5 may be changed based on circumstances such as a season or presence or absence of an event.

Next, the device monitoring program 33 searches for offering information stored in the data storage unit 35, and when newly arrived offering information is present, the device monitoring program 33 displays the offering information screen 53 as illustrated in FIG. 3C as a pop-up based on the newly arrived offering information (T21). That is, similarly to the first status information screen 50 related to the status information, the device monitoring program 33 displays the offering information screen 53 related to the offering information as a pop-up. This processing is an example of the second display processing, and the offering information screen 53 is an example of a second notification image.

In this processing, when no newly arrived offering information is present, the device monitoring program 33 may display the offering information screen 53 as a pop-up on the first home screen 42A based on latest offering information. Further, when no newly arrived offering information is present and the first status information screen 50 is displayed on the first home screen 42A, the device monitoring program 33 may search for offering information stored in the data storage unit 35 based on the model name displayed in the model name display field 50C on the first status information screen 50, and may display the offering information screen 53 as a pop-up on the first home screen 42A based on the extracted offering information.

### Display of Notification List

Next, in a state in which the information processing apparatus 200 displays the status information screen 50 or displays the offering information screen 53, when the user clicks a notification list button portion displayed in the notification list button display field 50G on the first status information screen 50 or the notification list button display field 53B on the offering information screen 53 with the mouse 41 (T31), the device monitoring program 33 displays all notifications for the monitored device 1 on the display 42 as a notification list screen 54, based on the notification information stored in the data storage unit 35 (T32).

The notification list screen 54 displays notification objects 54A to 54D. Further, each of the notification objects 54A to 54D displays a notification date, a notification message, a target model name, and the like. Then, when a click operation with the mouse 41 on each of the objects 54A to 54D is received, a detailed information screen or a reference information screen are displayed.

The device control program 34 refers to the offering information stored in the data storage unit 35 by the device monitoring program 33 in T24, and displays the notification list screen 54 based on the referred offering information. Even when the user clicks a “notification list” tab 83A portion with the mouse 41, the notification list screen 54 can be displayed on a setting screen 80.

As described above, in the present embodiment, since the notification information for all the devices 1 monitored by the device monitoring program 33 is stored in the data storage unit 35, and the device monitoring program 33 displays the notification list screen 54 on the display 42 based on the notification information stored in the data storage unit 35, the user can properly understand the offering information currently provided to the device 1.

Further, in a state in which the device monitoring program 33 displays the first status information screen 50 or the offering information screen 53, when the user clicks a character portion or an illustration portion on the display screen of the first status information screen 50 or the offering information screen 53 with the mouse 41 (T33), the device monitoring program 33 activates the device control program 34, and as illustrated in FIG. 5, displays a detailed information screen or a reference information screen (not illustrated) on the display 42 for all notifications for the monitored device 1, based on the notification information stored in the data storage unit 35 (T34).

In the present embodiment, the information processing apparatus 200 is configured, in response to a display instruction, to display the notification list screen 54, the detailed information screen, the reference information screen, and the like on the display 42 based on the notification information stored in the data storage unit 35. However, the information processing apparatus 200 may also be configured, in response to a display instruction (T31, T33), to access the server 5 and display the notification list screen 54 and the like on the display 42 based on latest notification information downloaded therefrom (T32, T34). With this configuration, the user can view the latest notification list screen 54 and the like related to the device 1, and can prevent an erroneous operation based on old information.

In the present embodiment, the device monitoring program 33 is configured to display the notification list screen 54, the detailed information screen, and the reference information screen. However, the device monitoring program 33 may be configured to activate the device control program 34 to display the notification list screen 54, the detailed information screen, the reference information screen, and the like.

As described above, in the present embodiment, since the notification list screen 54, the detailed information, and the reference information are displayed on the display 42 based on an operation of the user, the information desired by the user can be provided in a timely manner, improving convenience. Further, since the detailed information and the reference information are acquired from the server 5, the user can always acquire the latest information, improving convenience.

The notification information displayed on the notification list screen 54, the detailed information and reference information screens displayed on the display 42 may be configured to display only information unread by the user on the display 42, or may be configured to display information limited by an acquisition period, an issuance period, or the like on the display 42. Further, it may be configured to preferentially display information related to a campaign or the like.

### SECOND EMBODIMENT

Next, FIG. 6 is a sequence diagram illustrating an example of a procedure for display processing of status information and offering information, which is implemented by the device monitoring program 33 and the device control program 34 of the information processing apparatus 200, including operations of the device 1 and the server 5.

Each processing procedure in the present embodiment represents processing of the CPU 21 according to an instruction described in programs such as the device monitoring program 33 and the device control program 34 of the information processing apparatus 200. The processing by the CPU 21 also includes a hardware control using an API of the OS. In the present specification, a detail description of the OS is omitted, and an operation of each program is described. In the description, the same components as those in the first embodiment are denoted by the same reference numerals. In addition, in the present specification, for convenience, processing primarily performed by the CPU 21 may be described as being primarily performed by a program or a device.

### Display of Status Information and Offering Information

That is, when the user clicks a box display button 45 portion displayed in a notification area of the taskbar 44 displayed on the display 42 with the mouse 41 to instruct a display of a box (T41), as illustrated in FIG. 7, the device monitoring program 33 displays a box 60 on the display 42 by the OS 31, and displays, within the box 60, a first icon 61 of the device monitoring program 33, which is a resident program (T42). The first icon 61 is displayed accompanied by a first badge 62. The box 60 is an area in which icons of resident programs can be displayed, and can also be referred to as an icon display area.

As illustrated in FIG. 7, the device monitoring program 33 changes a display method of the first badge 62 based on a type of information acquired from the monitored device, for example, the device 1 or the server 5 via the network interface 27.

Specifically, when the status information acquired from each device 1 to be monitored includes status information related to an error, the device monitoring program 33 displays, for example, a red first badge 62A. Further, when the status information acquired from each device 1 does not include the status information related to an error but includes status information related to a warning, the device monitoring program 33 displays, for example, a yellow first badge 62B.

Further, when the status information acquired from each device 1 to be monitored does not include the status information related to the error and the information related to the warning, and new offering information is acquired from the server 5, that is, when unread offering information is stored in the data storage unit 35, the device monitoring program 33 displays, for example, a first badge 62C with a white bell mark on a pink background.

Further, when the status information acquired from each device 1 to be monitored does not include the status information related to an error and the information related to a warning, does not store unread offering information, but includes status information related to readiness, the device monitoring program 33 displays, for example, a green first badge 62D. When the information processing apparatus 200 does not store unread offering information and all the devices 1 to be monitored are offline, the information processing apparatus 200 displays, for example, a gray first badge 62E. In the following description, when there is no need to distinguish the first badges 62A to 62E, the subscripts for distinguishing A to E will be omitted and the first badges 62A to 62E will be described as the first badge 62. The first badge 62 is an example of an icon.

In a display of the first badge 62 in the box 60, a priority is determined based on a type of the status information and the offering information, and the device monitoring program 33 displays one first badge 62 among the first badges 62A to 62E based on the priority.

Specifically, as illustrated in FIG. 8, the first badge 62 having a highest display priority is the red first badge 62A indicating that the status information is an error. The first badge 62 having a next highest priority is the yellow first badge 62B indicating that the status information is a warning. The first badge 62 having a next highest priority is the first badge 62C indicating that unread offering information is stored. The first badge 62 having a next highest priority is the green first badge 62D indicating that the status information is ready. The first badge 62 having a next highest priority is the gray first badge 62E indicating that the status information is offline.

As described above, in the present embodiment, since the badge is displayed regardless of whether the notification is related to the status information or the offering information, the user can understand what information is being notified by viewing the badge. In addition, in a case in which the status information is an error or a warning, since the display priority is set to be higher than that of other status information, the user can quickly respond to the error or the warning.

The red first badge 62A and the yellow first badge 62B each are an example of a first mode, and the first badge 62C is an example of a second mode.

FIG. 9 is a flowchart illustrating an example of a procedure for badge display processing, which is implemented by the CPU 21 of the information processing apparatus 200 sequentially processing according to commands described in the device monitoring program 33. The badge display processing is periodically executed by the CPU 21 at regular intervals. Alternatively, the processing may be executed every time status information or offering information is acquired.

First, the information processing apparatus 200 reads status information and offering information stored in the data storage unit 35 (step 51 (hereinafter, referred to as S51)).

Next, the device monitoring program 33 determines whether new status information or unread offering information is present (S52). The “new status information” here means that the status of the device 1 to be monitored has changed. If the information processing apparatus 200 determines that no new status information or unread offering information is present (S52: NO), the device monitoring program 33 maintains the current display of the first badge 62 (S53), and this processing ends.

If the device monitoring program 33 determines that new status information or unread offering information is present (S52: YES), then the device monitoring program 33 determines whether the first badge 62 is currently displayed (S54). If the device monitoring program 33 determines that the first badge 62 is not currently displayed (S54: NO), then the device monitoring program 33 displays the first badge 62 determined based on the priority described above based on the new status information or the unread offering information (S55), and then this processing ends.

If the device monitoring program 33 determines that the first badge 62 is currently displayed (S54: YES), the device monitoring program 33 determines whether the new status information or the unread offering information has a higher priority than the first badge 62 currently displayed (S56). If the device monitoring program 33 determines that the new status information or the unread offering information has a higher priority than the currently displayed first badge 62 (S56: YES), then the device monitoring program 33 proceeds to processing in S55, and displays the first badge 62 corresponding to the new status information or the unread offering information, and then this processing ends.

If the device monitoring program 33 determines that the new status information or the unread offering information does not have a higher priority than the currently displayed first badge 62 (S56: NO), then the information processing apparatus 200 proceeds to processing in S53, and maintains the current display of the first badge 62, and this processing ends.

The determination of the priority is executed based on the priority illustrated in FIG. 8 described above. In the present embodiment, the display priority of the first badge 62C indicating that the unread offering information is acquired is set to be higher than the green first badge 62D indicating that the status information is ready and the gray first badge 62E indicating that the status information is offline, and is set to be lower than the red first badge 62A indicating that the status information is an error and the yellow first badge 62B indicating that the status information is a warning. However, the display priority of the first badge 62C is not limited thereto. Further, the priority of the status information may be set based on a type of the unread offering information.

Returning to the sequence diagram illustrating the example of the procedure for the display processing of the status information and the offering information illustrated in FIG. 6, when the user clicks a first icon 61 portion illustrated in FIG. 7 with the mouse 41 to instruct a display of an activation box 63 (T43), the information processing apparatus 200 displays the activation box 63 on the display 42, as illustrated in FIG. 10 (T44).

In the activation box 63, characters 63A “activate control program”, characters 63B “notification list”, and the like are displayed, respectively.

Here, when the user clicks a portion of the characters 63A “activate control program” in the activation box 63 with the mouse 41 to instruct activation of the device control program 34 (T45), the device monitoring program 33 activates the device control program 34 (T46).

The device control program 34 can also be activated by the user clicking an icon 43 portion illustrated in FIG. 2 with the mouse 41. Further, a shortcut icon for activating the device control program 34 may be provided in the taskbar 44. When the user clicks a portion of the characters 63B “notification list” with the mouse 41, the device monitoring program 33 instructs the device control program 34 to display the notification list screen 54.

Here, when the device control program 34 is activated in the device monitoring program 33, the device control program 34 displays a second home screen 70 of the device control program 34 on the display 42 (T47).

As illustrated in FIG. 11, on the second home screen 70, icons corresponding to functions available in the selected printer, for example, a print icon 71 and a scan icon 72 are displayed. The second home screen 70 includes a control model name display field 73 indicating a name of the selected printer, a status information display field 74 indicating a status of the selected printer, and an ink remaining amount display field 75 indicating a consumable remaining amount of the selected printer.

That is, the print icon 71 is used to instruct the selected printer to perform printing. The scan icon 72 is used to instruct the selected printer to read an image. In the control model name display field 73, one of the devices 1 to be monitored by the device monitoring program 33 is selected as a control target of the device control program 34, and a name of the selected device, specifically, a model name of the device 1 is displayed. Further, the status information on the device 1 displayed in the control model name display field 73 is displayed in the status information display field 74. When the device 1 displayed in the control model name display field 73 is the printer 1A, an ink remaining amount of the printer 1A is displayed in the ink remaining amount display field 75.

When the device control program 34 is activated, the device control program 34 displays a second icon 76 of the device control program 34 in the taskbar 44 on the first home screen 42A (T48). The second icon 76 is displayed accompanied by a second badge 77 as necessary. Specifically, the device control program 34 displays, in the second badge 77, the number of unread offering information among the offering information for all the devices 1 to be monitored by the device monitoring program 33, which is stored in the data storage unit 35. That is, the second badge 77 illustrated in FIG. 11 indicates a state in which 20 pieces of unread offering information related to all the devices 1 to be monitored by the device monitoring program 33 are present. When the number of pieces of unread offering information is 0, the second badge 77 may not be displayed, or the second badge 77 indicating 0 may be displayed.

As described above, in the present embodiment, when the device control program 34 is activated, the second icon 76 and the second badge 77 are displayed in the taskbar 44, and thus the user can easily know the number of pieces of unread offering information related to all the devices 1 by the second badge 77. Therefore, an opportunity for the user to read the offering information increases, and as a result, an opportunity to receive the service increases.

When status information on an error or status information on a warning having a higher priority than the unread offering information is acquired from the device 1 having a model name displayed in the control model name display field 73, the red or yellow second badge 77 is displayed in the taskbar 44 on the second home screen 70 instead of the number of pieces of the unread offering information.

As described above, in the present embodiment, when the status information on an error or the status information on a warning having a higher priority than the unread offering information is acquired, the red or yellow second badge 77 is displayed in the taskbar 44 on the second home screen 70 instead of the number of pieces of the unread offering information, and thus the user can quickly respond to the error or the warning.

As described in detail above, according to the first embodiment and the second embodiment disclosed in the present specification, the device monitoring program 33 can effectively provide various information on the device to be monitored to the user by displaying a notification related to the offering information related to the device to be monitored in the same display format as the information based on the status, that is, displaying both notifications in a display format of a pop-up display. Further, the monitoring program can also effectively provide various information on the device to be monitored to the user by displaying a notification related to the offering information related to the device to be monitored in the same display format as the information based on the status, that is, displaying both notifications in a display format using icon badges. The display format using icon badges is an example of a display format via an icon.

The present embodiment is merely an example, and does not limit the present disclosure. Therefore, various improvements and modifications can be naturally made to the present disclosure without departing from the scope thereof. For example, the printer 1A may not include the operation panel 13.

The present embodiment is merely an example, and does not limit the present disclosure. Therefore, various improvements and modifications can be naturally made to the present disclosure without departing from the scope thereof. For example, the printer 1A may not include the operation panel 13. The information processing apparatus 200 is not limited to the non-volatile memory 24, and may include any type of large-capacity storage device.

In the present embodiment, a difference in the mode is expressed by changing display colors of the first badge and the second badge based on a type of the status information. However, the difference in the mode may be expressed by presence or absence of blinking of the first badge and the second badge or a change in blinking interval.

Further, in the processing in T12, when the information processing apparatus 200 receives highly urgent status information such as a sheet jam, the information processing apparatus 200 may be configured to immediately display any one of the first to third status information screens 50 to 52 on the display 42 based on the received status information to notify the user.

The communication method between the printer 1A and the information processing apparatus 200 is not limited to wireless communication conforming to the Wi-Fi (registered trademark) standard. For example, the communication method may be wired communication using a USB cable or wireless communication based on other standards such as Bluetooth (registered trademark). Further, a plurality of communication functions may be provided.

The processing disclosed in the embodiment may be executed by hardware such as a single CPU, a plurality of CPUs, an ASIC, or a combination thereof. In addition, the processing disclosed in the embodiment can be implemented in various modes such as a recording medium in which a program for executing the processing is recorded, or a method.

What is claimed is:

1. A non-transitory computer readable storage medium storing a program that is a resident program, the program, when executed by a processor of an information processing apparatus, causing the information processing apparatus to perform operations, the operations comprising:
communicating, via a communication device of the image processing apparatus, with an image processing device to be monitored;
acquiring a status of the image processing device through a communication with the image processing device;
displaying a first notification image based on the status acquired in the acquiring the status of the image processing device;
acquiring service-related information related to a service available to the image processing device to be monitored; and
displaying a second notification image related to the service-related information acquired in the acquiring the service-related information, a display format of the second notification image being the same as a display format of the first notification image.

2. The non-transitory computer readable storage medium according to claim 1,
wherein the operations comprise displaying an icon corresponding to the program, each of the display format of the first notification image and the display format of the second notification image being a display format via the icon,
wherein in the displaying the first notification image, the icon in a first mode is displayed as the first notification image, the icon in the first mode corresponding to the status acquired in the acquiring the status of the image processing device, and
wherein in the displaying the second notification image, the icon in a second mode is displayed as the second notification image, the icon in the second mode indicating that the service-related information acquired in the acquiring the service-related information is present.

3. The non-transitory computer readable storage medium according to claim 2, wherein the operations comprise, in a case in which the status acquired in the acquiring the status of the image processing device includes a content indicating an error or a warning, displaying the icon in the first mode while restricting a display of the icon in the second mode.

4. The non-transitory computer readable storage medium according to claim 3, wherein the operations comprise, in a case in which the status acquired in the acquiring the status of the image processing device does not include the content indicating the error or the warning and in a case in which there is unread service-related information in the service-related information acquired in the acquiring the service-related information, displaying the icon in the second mode while restricting a display of the icon in the first mode.

5. The non-transitory computer readable storage medium according to claim 2,
wherein the operations further comprise activating a display program that is a non-resident program, the display program, when executed by the processor, causing the information processing apparatus to perform display operations comprising displaying a list of the service-related information acquired in the acquiring the service-related information, the display operations further comprising, in response to activation of the display program, displaying an icon corresponding to the display program, the icon corresponding to the display program including a specific mode indicating that unread service-related information in the service-related information acquired in the acquiring the service-related information is present, and
wherein the second mode of the icon corresponding to the program is different from the specific mode of the icon corresponding to the display program.

6. The non-transitory computer readable storage medium according to claim 5,
wherein the icon in the specific mode indicates a number of pieces of the unread service-related information, and
wherein the icon in the second mode does not indicate the number of pieces of the unread service-related information.

7. The non-transitory computer readable storage medium according to claim 2,
wherein the icon in the first mode is an icon to which a first badge with a first color is assigned, the first color being determined in accordance with a content of the status from among one or more different colors for the first badge, and
wherein the icon in the second mode is an icon to which a second badge with a second color is assigned, the second color being not included in the one or more different colors for the first badge.

8. The non-transitory computer readable storage medium according to claim 1,
wherein each of the display format of the first notification image and the display format of the second notification image is a pop-up display,
wherein in the displaying the first notification image, the first notification image is displayed as a pop-up, and
wherein in the displaying the second notification image, the second notification image is displayed as a pop-up.

9. The non-transitory computer readable storage medium according to claim 8, wherein the operations further comprise:
acquiring progress information indicating a progress of a job causing the image processing device to perform image processing; and
displaying a third notification image based on the progress information acquired in the acquiring the progress information, a display format of the third notification image being the same as the display format of the first notification image.

10. The non-transitory computer readable storage medium according to claim 9,
wherein the operations further comprise acquiring consumable information indicating information on a consumable in the image processing device through the communication with the image processing device,
wherein the first notification image includes the consumable information acquired in the acquiring the consumable information, and
wherein the third notification image does not include the consumable information.

11. The non-transitory computer readable storage medium according to claim 8,
wherein the program, when executed by the processor, allows the information processing apparatus to monitor a plurality of image processing devices,
wherein the displaying the first notification image comprises:
receiving a selection of an image processing device to be displayed among the plurality of image processing devices to be monitored; and
displaying the first notification image based on the status of the selected image processing device, and
wherein the displaying the second notification image comprises displaying the second notification image without receiving the selection of the image processing device to be displayed.

12. The non-transitory computer readable storage medium according to claim 8,
wherein the service-related information includes information related to one or more services associated with respective one or more types of error or warning,
wherein the operations further comprise, in a case in which the status acquired in the acquiring the status of the image processing device is an error or a warning, extracting, from the service-related information acquired in the acquiring the service-related information, information related to a service associated with a type of error or warning corresponding to the type of error or warning indicated in the status acquired in the acquiring the status of the image processing device, and
wherein the displaying the first notification image comprises, in case in which there is the information extracted in the extracting the information related to the service, displaying the first notification image including the information extracted in the extracting information related to the service.

13. The non-transitory computer readable storage medium according to claim 8,
wherein the acquiring the service-related information comprises storing the acquired service-related information in a memory of the information processing apparatus, and
wherein the operations further comprise:
receiving an instruction to display a list of the acquired service-related information during the second notification image being displayed; and
displaying a list of the service-related information stored in the memory in a case in which the instruction is received.

14. The non-transitory computer readable storage medium according to claim 1,
wherein the acquiring the service-related information comprises:
communicating, via the communication device, with a server configured to provide the service-related information; and
acquiring the service-related information related to the image processing device to be monitored.

15. An information processing apparatus comprising:
a communication device;
a processor; and
a memory storing a program that is a resident program, the program, when executed by the processor, causing the information processing apparatus to perform operations, the operations comprising:
communicating, via the communication device, with an image processing device to be monitored;
acquiring a status of the image processing device through a communication with the image processing device;
displaying a first notification image based on the status acquired in the acquiring the status of the image processing device;
acquiring service-related information related to a service available to the image processing device to be monitored; and
displaying a second notification image related to the service-related information acquired in the acquiring the service-related information, a display format of the second notification image being the same as a display format of the first notification image.

16. A method for controlling an information processing apparatus, the information processing apparatus comprising a processor and a communication device, the method comprising:
executing a program by the processor, the program being a resident program, to cause the information processing apparatus to perform operations, the operations comprising:
communicating, via the communication device, with an image processing device to be monitored;
acquiring a status of the image processing device through a communication with the image processing device;
displaying a first notification image based on the status acquired in the acquiring the status of the image processing device;
acquiring service-related information related to a service available to the image processing device to be monitored; and
displaying a second notification image related to the service-related information acquired in the acquiring the service-related information, a display format of the second notification image being the same as a display format of the first notification image.

17. The method according to claim 16,
wherein the operations comprise displaying an icon corresponding to the program, each of the display format of the first notification image and the display format of the second notification image being a display format via the icon,
wherein in the displaying the first notification image, the icon in a first mode is displayed as the first notification image, the icon in the first mode corresponding to the status acquired in the acquiring the status of the image processing device, and
wherein in the displaying the second notification image, the icon in a second mode is displayed as the second notification image, the icon in the second mode indicating that the service-related information acquired in the acquiring the service-related information is present.

18. The method according to claim 17, wherein the operations comprise, in a case in which the status acquired in the acquiring the status of the image processing device includes a content indicating an error or a warning, displaying the icon in the first mode while restricting a display of the icon in the second mode.

19. The method according to claim 18, wherein the operations comprise, in a case in which the status acquired in the acquiring the status of the image processing device does not include the content indicating the error or the warning and in a case in which there is unread service-related information in the service-related information acquired in the acquiring the service-related information, displaying the icon in the second mode while restricting a display of the icon in the first mode.

20. The method according to claim 17,
wherein the operations further comprise activating a display program that is a non-resident program, the display program, when executed by the processor, causing the information processing apparatus to perform display operations comprising displaying a list of the service-related information acquired in the acquiring the service-related information, the display operations further comprising, in response to activation of the display program, displaying an icon corresponding to the display program, the icon corresponding to the display program including a specific mode indicating that unread service-related information in the service-related information acquired in the acquiring the service-related information is present, and
wherein the second mode of the icon corresponding to the program is different from the specific mode of the icon corresponding to the display program.
